(19) United States
(12) Patent Application Publication
(10) Pub. No.: US 2026/0363205 A1
(43) Pub. Date: Nov. 19, 2026

(54) COMMUNITY ADJUSTMENT MECHANISM FOR DROP FEEDERS

(71) Applicant: THE GSI GROUP, LLC, Assumption, IL (US)

(72) Inventors: Alan C. Hogan, Mt. Zion, IL (US); Brad K. Eversole, Shelbyville, IL (US)

(21) Appl. No.: 19/487,443

(22) PCT Filed: Apr. 25, 2024
(86) PCT No.: PCT/IB2024/054033

§ 371 Date: Nov. 24, 2025

Related U.S. Application Data
(60) Provisional application No. 63/469,710, filed on May 30, 2023.

(51) Int. Cl. A01K 5/02

(52) U.S. Cl. CPC A01K 5/0225; A01K 5/0258; A01K 5/0275

(57) ABSTRACT

A feeding system includes a feed tube and a plurality of drop feeders. Each drop feeder has a feed level control mechanism with adjustment lever that selectively determines the amount of feed in the feeder. A feed level adjustment system connects to each adjustment lever and includes a first and second mounting brackets having a front plate extending from the mounting bracket on a front side and a rear plate extending on a back side. A first adjustment lead connects to the adjustment lever of each drop feeder. An actuating apparatus causes movement of the first adjustment lead. A rear counterbalance member extends between the rear plate to the rear plate at the second end such that the rear counterbalance member is positioned on the back side of the feed tube to counterbalance forces placed on the feed tube by the first adjustment lead.

### BACKGROUND OF THE INVENTION

### Field of Invention

The present disclosure is generally related to livestock feeding systems and, more particularly, to apparatus for simultaneously adjusting the amount of feed delivered by each drop feeder in the livestock feeding system.

### Description of Related Art

In livestock buildings such as open pen swine feeding facilities, it is customary to use drop feeders to provide a rationed amount of feed to individual animals. It is desirably for proper animal health to provide differing amounts of feed to each animal based on animal age, lactation, and/or gestation phase of the animal based on the best “feed curve” for the animal.

Typically, each drop feeder in the livestock building must be periodically adjusted to control the amount of feed the drop feeder provides to the animal. Changing feeder settings requires the operator to enter the livestock stalls and climb over the livestock stalls to make the adjustment. This is not only a labor intensive evolution, but disrupts the animals and potentially causes safety issues for the operator.

### BRIEF SUMMARY

One aspect of the invention is directed to a feeding system for delivering feed to a plurality of stalls in a livestock building. The feeding system includes a feed tube that extends along a length of the feeding system and a plurality of drop feeders connected to the feed tube. Each drop feeder is formed with a container body having a top interface that mates with the feed tube forming a top feed inlet hole that delivers feed from the feed tube to the container body. Each drop feeder has a feed level control mechanism that selectively determines the amount of feed that will collect in the container body and an adjustment lever configured to manipulate the feed level control mechanism. The feeding system also includes a feed level adjustment system that connects to the adjustment lever for each drop feeder to simultaneously move the adjustment levers. The feed level adjustment system includes a first mounting bracket that connects to the feed tube at a first end of the feed tube having a front plate extending from the mounting bracket on a front side of the feed tube and a rear plate extending from the mounting bracket on a back side of the feed tube, and a second mounting bracket that connects to the feed tube at a second end of the feed tube having a front plate extending from the mounting bracket on a front side of the feed tube and a rear plate extending from the mounting bracket on a back side of the feed tube. A first adjustment lead connects to the adjustment lever of each drop feeder. An actuating apparatus includes an actuator handle pivotably connected to the front plate of the first mounting bracket at a pivot, where the first adjustment lead is attached to the actuator handle at a connection point so that movement of the actuator handle causes movement of the first adjustment lead. A rear counterbalance member extends between the rear plate at the first end of the feed tube to the rear plate at the second end such that the rear counterbalance member is positioned on the back side of the feed tube to counterbalance forces placed on the feed tube by the first adjustment lead on the front side of the feed tube.

Other technical features may be readily apparent to one skilled in the art from the following figures, descriptions, and claims. This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced. The disclosed subject matter will be further explained with reference to the attached figures, wherein like structure or system elements are referred to by like reference numerals throughout the several views.

FIG. 1 is a schematic of a feeding system having a plurality of drop feeders;

FIG. 2 is a front perspective view of a portion of the feeding system with an adjustment apparatus for the drop feeders;

FIG. 3 illustrates an enlarged perspective view of a drop feeder;

FIG. 4 illustrates an exploded view of a drop feeder;

FIG. 5 illustrates a portion of the adjustment apparatus for the drop feeders;

FIG. 6 is a rear perspective view of a portion of the feeding system and the adjustment apparatus for the drop feeders; and

FIG. 7 is a rear elevation view of a portion of the feeding system and the adjustment apparatus for the drop feeders.

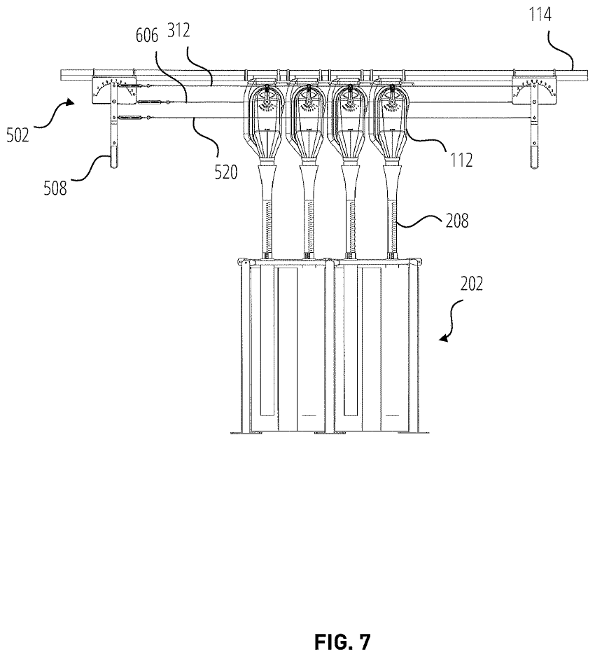

### DETAILED DESCRIPTION

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all the elements that form a complete structure or assembly. Only those process acts and structures necessary to understand the embodiments of the disclosure are described in detail below. Additional conventional acts and structures may be used. The drawings accompanying the application are for illustrative purposes only, and are thus not drawn to scale.

As used herein, the singular forms following “a,” “an,” and “the” are intended to include the plural forms as well, unless the context clearly indicates otherwise. As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded. As used herein, the term “configured” refers to a size, shape, material composition, and arrangement of one or more of at least one structure and at least one apparatus facilitating operation of one or more of the structure and the apparatus in a predetermined way.

As used herein, any relational term, such as “first,” “second,” “top,” “bottom,” “upper,” “lower,” “above,” “beneath,” “side,” etc., is used for clarity and convenience in understanding the disclosure and accompanying drawings, and does not connote or depend on any specific preference or order, except where the context clearly indicates otherwise.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.). As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

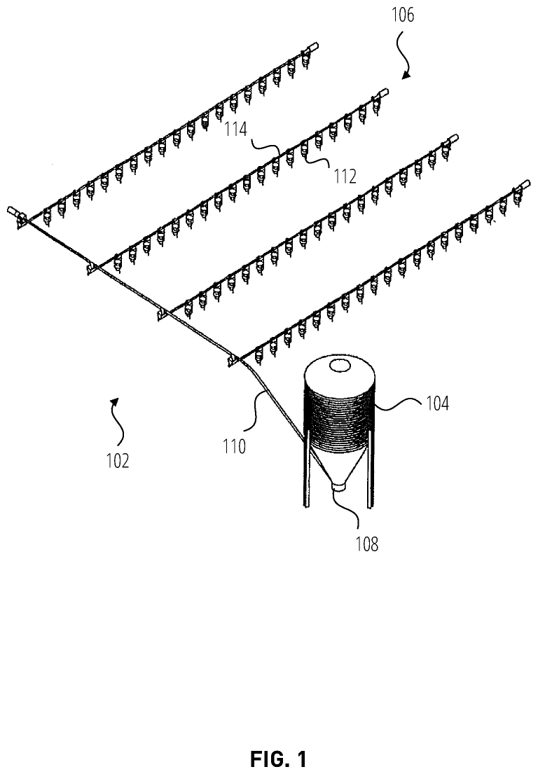

FIG. 1 illustrates a feed dispenser system 102 designed to hold and deliver feed to livestock such as swine within a livestock building (not shown). The feed dispenser system 102 includes a bulk feed tank 104 located proximate the livestock facility in which a feeding system 106 is installed. The bulk feed tank 104 has an outlet boot 108 for directing feed from within the bulk feed tank 104 to the feeding system 106 through a conveyor tube 110 in which a suitable auger or other conveyance means is driven. The bulk feed tank 104 and the conveyor tube 110 delivering feed to the feeding system 106 may be of any design and would be known to one skilled in the art and need not be discussed herein.

Within the livestock building, the feeding system 106 includes a plurality of drop feeders 112 each connected to a feed tube 114 which delivers the feed to the drop feeders 112. Typically, an auger (not shown) extends through the feed tube 114 and is driven by a suitable motor (not shown) to carry the feed from the conveyor tube 110 through the feed tube 114 to the drop feeders 112. As can be appreciated, the drop feeders 112 will fill with feed in a consecutive manner. When the final drop feeder 112 in the feeding system 106 fills with feed, a suitable sensor will sense this condition and cause a controller to deactivate the motor and stop the delivery of feed through the feeding system 106 as would be understood by one skilled in the art.

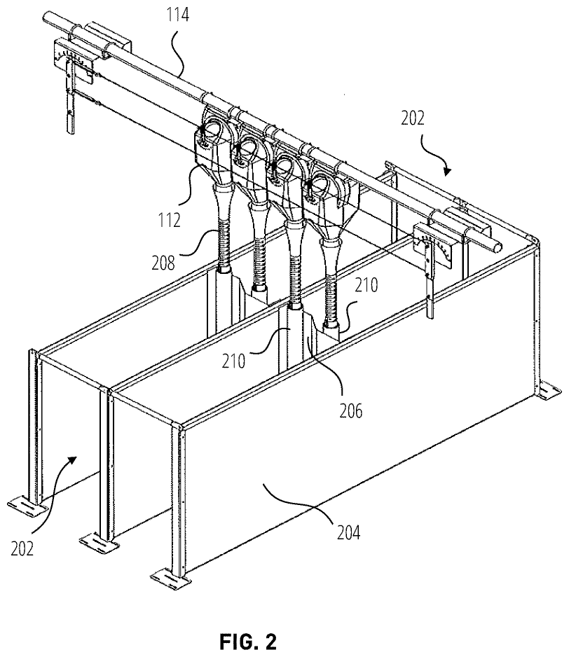

Turning now to FIG. 2, the livestock building contains a plurality of feeding stalls 202 with the feed tube 114 extending above the stalls 202 suspended from the ceiling of the livestock building. Each feeding stall 202 is each configured to receive an animal to be feed and is formed by side barriers 204 and a head barrier 206. Each drop feeder 112 is associated with one of the feeding stalls 202. Desirably, an adjustable drop tube 208 extends downwardly from the drop feeder 112 to a built-in drop tube 210 in the head barrier 206 to deliver feed to the animal in the feeding stall 202.

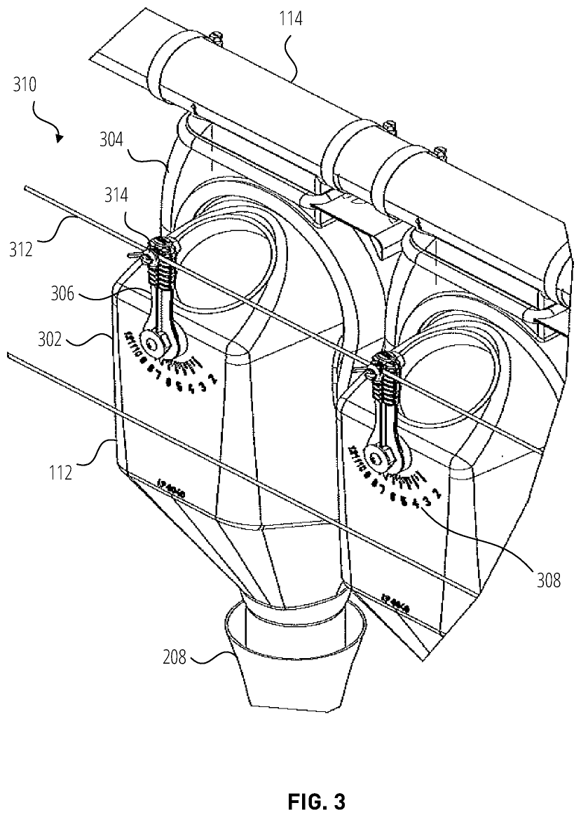

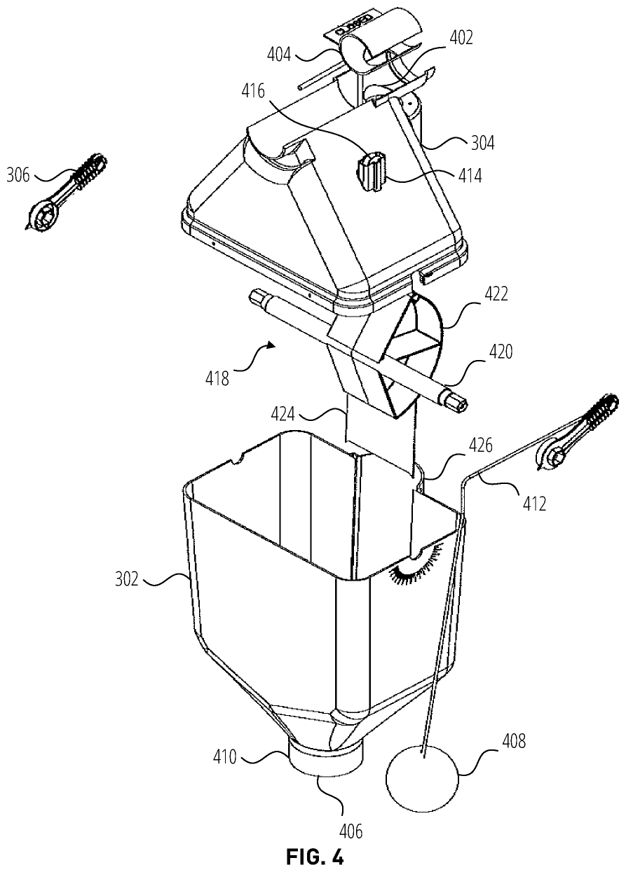

Turning also now to FIGS. 3 and 4, the drop feeder 112 is formed with a container body 302 having a top interface 304 that mates with the feed tube 114 such that a top feed inlet hole 402 in the interface 304 delivers feed to the container body 302. Desirably, the drop feeder 112 has a shut off slide 404 that can be positioned to close off the top feed inlet hole 402 so that feed is unable to enter the drop feeder 112 from the feed tube 114. A bottom feed outlet hole 406 in a lower portion of the container body 302 mates with the adjustable drop tube 208. The drop feeder 112 has gravity drop feed valve that includes a drop ball 408 that mates with a container seat 410 in the container body 302 to seal the bottom feed outlet hole 406 allowing feed to collect in the container body 302. The feed is selectively delivered from the container body 302 down the adjustable drop tube 208 through the bottom feed outlet hole 406 by raising the drop ball 408 with a ball actuator 412. In the illustrated embodiment, the ball actuator 412 extends through a ball actuator port 414 in the top interface 304 and around drop ball pulley 416 so that the ball actuator 412 for each drop feeder 112 in the feeding system 106 can be actuated remotely from the drop feeder 112 as is known in the art such as in the Ultra-Drop™ Feeder available from Automated Production Systems.

Desirably, the drop feeder 112 contains a feed level control mechanism 418 that allows a user to selectively determine the amount of feed that will collect in the container body 302 based on animal age, lactation and/or gestation phase of the animal. In one embodiment, the feed level control mechanism 418 can be manipulated to select an amount of feed between 2 lbs. (0.9 kg) and 12 lbs. (5.5 kg), however the drop feeder 112 may be designed to hold other amounts of feed. The drop feeder 112 has an adjustment lever 306 that is used to manipulate the feed level control mechanism 418. In one embodiment, the adjustment lever 306 is mounted on a shaft 420 such that pivoting movement of the adjustment lever 306 pivots the shaft 420 to selectively manipulate the feed level control mechanism 418. In one embodiment of the feed level control mechanism 418, the adjustment lever 306 is rigidly attached to a drum 422 and when the adjustment lever 306 is rotated clockwise or counterclockwise, the drum 422 rotates with it. As the drum 422 rotates, it rolls up or rolls out an adjustment slide 424. The adjustment slide 424 moves vertically in a track to create a moveable wall in a feed chute 426 in the container body 302. When the feed conveyer in the feed tube 114 runs, it conveys feed to the top feed inlet hole 402 in the top of the feeder 112. The feed drops through this top feed inlet hole 402, flows down through the chute 426, and fills up the bottom of the container body 302 at the “angle of repose” of the feed, beginning at the bottom of the adjustment slide 424. When the drop ball 408 at the bottom of the drop feeder 112 is raised up, the feed that was trapped above the drop ball 408 flows out the bottom feed outlet hole 406 of the drop feeder 112 to the drop tube 208. When the drop ball 408 is lowered back down, the bottom feed outlet hole 406 is sealed to allow the drop feeder 112 to be filled again.

Desirably, an outer surface of the container body 302 adjacent the adjustment lever 306 has feed level indicia 308 so that an operator may know how much feed will be collected in the drop feeder 112 based on the selected position of the adjustment lever 306.

A feed level adjustment system 310 connects to the adjustment lever 306 for each individual drop feeder 112 so that the feed level adjustment system 310 can simultaneously adjust the adjustment levers 306 for multiple drop feeders 112 in the feeding system 106. In one embodiment, the feed level adjustment system 310 includes a first adjustment lead 312 that connects to the adjustment lever 306 of each drop feeder 112 in the feeding system 106 to be adjusted by the feed level adjustment system 310. While in the illustrated embodiment the first adjustment lead 312 is a tension cable, the first adjustment lead 312 may be any suitable cable or rod configured to operate as either a tension member or compression member capable of effecting movement of the adjustment levers 306. The first adjustment lead 312 connects to the adjustment lever 306 of each drop feeder 112 at a connection point 314 using a suitable cable clamp or other known connection means. The first adjustment lead 312 may be routed throughout the livestock building so that it reaches each of the drop feeders 112 to be controlled by the feed level adjustment system 310 using one or more pulleys, cable-to-cable connections, rod-to-rod connection, cable-to-rod connections, or other routing means using sound engineering judgment as would be understood by one skilled in the art.

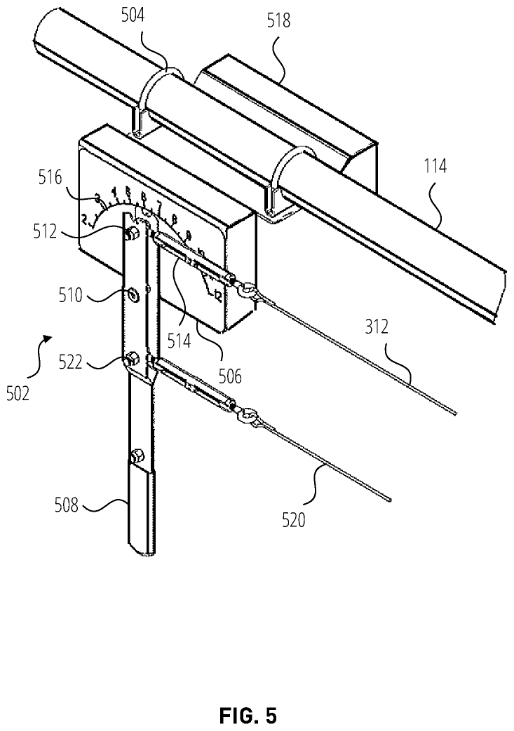

Turning also now to FIG. 5, the feed level adjustment system 310 contains an actuating apparatus 502 adjacent the feed tube 114 to which the drop feeders 112 are attached. In one embodiment, a mounting bracket 504 connects to the feed tube 114 and includes a front plate 506 extending from the mounting bracket 504 on a front side of the feed tube 114. The actuating apparatus 502 includes an actuator handle 508 pivotably connected to the front plate 506 at pivot 510. The first adjustment lead 312 is attached to the actuator handle 508 at an upper connection point 512 so that movement of the actuator handle 508 causes movement of the first adjustment lead 312. Accordingly, movement of the actuator handle 508 controls movement of the adjustment levers 306 for all the drop feeders 112 in the feeding system 106 connected to the feed level adjustment system 310 at the same time and by the same amount. Desirably, the first adjustment lead 312 is connected to the actuator handle 508 with suitable connecting hardware 514 such as a turnbuckle to aid in connection and proper tensioning of the first adjustment lead 312 with the actuator handle 508. Desirably, the front plate 506 has actuator level indicia 516 so that the operator can use the position of the actuator handle 508 to select the amount of feed supplied by the feed level control mechanism 418 for each of the drop feeder 112 in the feeding system 106. Alternately, the front plate 506 may house an electronic actuator such that the actuator handle 508 can be controlled electronically. As the operator moves the actuator handle 508, the operator can use the actuator level indicia 516 to select the desired setting. The actuator handle 508 is desirably fixed to a stall 202 or to the ceiling or wall of the livestock building in an accessible and convenient location for the operator, preferably without requiring the operator to climb over stalls 202 and into areas of the livestock building that may be occupied by animals.

In the illustrated embodiment, the actuating apparatus 502 has the actuator handle 508 positioned at a first end 602 of the feed tube 114 and also includes a second actuator handle 508 on a second mounting bracket 504 positioned at a second end 604 of the feed tube 114, with the first adjustment lead 312 extending between the actuator handles 508 at the first and second ends. In one embodiment, the feed level adjustment system 310 also includes a second adjustment lead 520 that connects between the actuator handle 508 at the first end 602 of feed tube 114 and the actuator handle 508 at the second end 604 of the feed tube 114. The first adjustment lead 312 is connected to the actuator handle 508 at an upper connection point 512 above the pivot 510 and the second adjustment lead 520 is connected to the actuator handle 508 at a lower connection point 522 below the pivot 510.

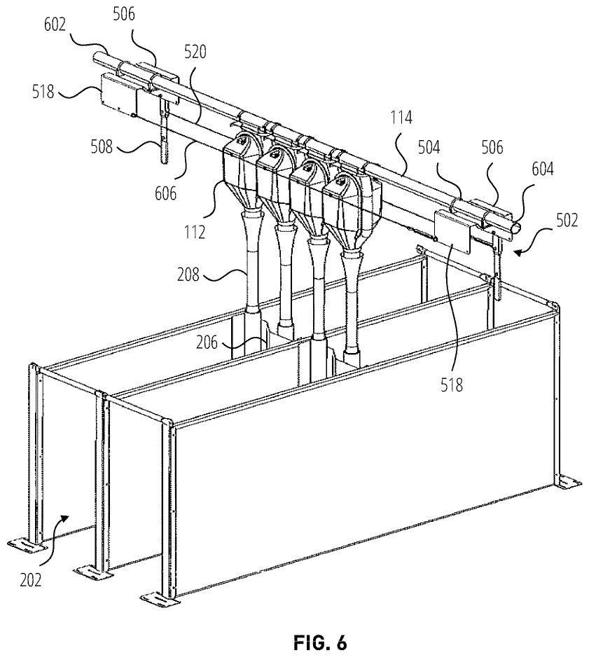

As best seen in the rear view of the feed tube 114 in FIG. 6, in the illustrated embodiment the actuating apparatus 502 the mounting bracket 504 also has a rear plate 518 extending from the mounting bracket 504 on a back side of the feed tube 114 at the first end 602 and second end 604 of the feed tube 114. A rear counterbalance member 606 extends between the rear plate 518 at the first end 602 to the rear plate 518 at the second end 604. The rear counterbalance member 606 on the back side of the feed tube 114 is configured to counterbalance forces placed on the feed tube 114 by the first adjustment lead 312 and second adjustment lead 520 on the front side of the feed tube 114.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

1. A feeding system for delivering feed to a plurality of stalls in a livestock building, the feeding system comprising:
a feed tube that extends along a length of the feeding system;
a plurality of drop feeders connected to the feed tube, wherein each drop feeder of the plurality of drop feeders is formed with a container body having a top interface that mates with the feed tube forming a top feed inlet hole 402 that delivers feed from the feed tube to the container body, each drop feeder having a feed level control mechanism that selectively determines an amount of feed that will collect in the container body and an adjustment lever configured to manipulate the feed level control mechanism;
a feed level adjustment system that connects to the adjustment lever for each drop feeder of the plurality of drop feeders to simultaneously move the adjustment levers, wherein the feed level adjustment system comprises:
a first mounting bracket connected to the feed tube at a first end of the feed tube having a front plate extending from the first mounting bracket on a front side of the feed tube and a rear plate extending from the first mounting bracket on a back side of the feed tube;
a second mounting bracket connected to the feed tube at a second end of the feed tube having a front plate extending from the second mounting bracket on the front side of the feed tube and a rear plate extending from the second mounting bracket on the back side of the feed tube;
a first adjustment lead that connects to the adjustment lever of each drop feeder; and
an actuating apparatus adjacent the feed tube, wherein the actuating apparatus includes an actuator handle pivotably connected to the front plate of the first mounting bracket at a pivot, wherein the first adjustment lead is attached to the actuator handle at a connection point so that movement of the actuator handle causes movement of the first adjustment lead; and
a rear counterbalance member extending between the rear plate at the first end of the feed tube to the rear plate at the second end such that the rear counterbalance member is positioned on the back side of the feed tube to counterbalance forces placed on the feed tube by the first adjustment lead on the front side of the feed tube.

2. The feeding system of claim 1, further comprising a second actuator handle on the second mounting bracket, with the first adjustment lead extending between the actuator handle on the first mounting bracket to the second actuator handle on the second mounting bracket.

3. The feeding system of claim 1, wherein the upper adjustment lead is a tension cable.

4. The feeding system of claim 1, wherein the actuator handle comprises a first actuator handle, the feed level adjustment system further comprising a second adjustment lead that connects between the first actuator handle at the first end of the feed tube and a second actuator handle at the second end of the feed tube, wherein the first adjustment lead is connected to each of the first actuator handle and the second actuator handle at an upper connection point above the pivot and the second adjustment lead is connected to each of the first actuator handle and the second actuator handle at a lower connection point below the pivot.

5. The feeding system of claim 1, wherein the front plate has actuator level indicia so that the position of the actuator handle shows the amount of feed to be supplied by the feed level control mechanism for each of the drop feeders in the feeding system.

6. The feeding system of claim 1, wherein the container body has a bottom feed outlet hole 406 in a lower portion that mates with a drop tube.

7. The feeding system of claim 1, wherein a final drop feeder of the feeding system includes a sensor configured to sense when the final drop feeder is filled with the feed.

8. The feeding system of claim 1, wherein an adjustable drop tube extends downwardly from the bottom feed outlet hole of each of the drop feeders.

9. The feeding system of claim 8, wherein each adjustable drop tube extends to a built-in drop tube in a head barrier of a respective stall of the plurality of stalls.

10. The feeding system of claim 1, further comprising a shut off slide configured to stop a flow of feed from feed tube to the top feed inlet hole.

11. The feeding system of claim 1, wherein each drop feeder further comprises:
a drop ball configured to mate with a bottom feed outlet hole of the container body; and
a ball actuator configured to lift or lower the drop ball.

12. The feeding system of claim 11, wherein the ball actuator extends through a ball actuator port and around a drop ball pulley in the top interface.

13. The feeding system of claim 1, wherein the adjustment lever is coupled to a shaft and configured to rotate a drum about an adjustment slide of a feed chute of the drop feeder.

14. The feeding system of claim 1, wherein each drop feeder includes a feed level indication on an outside of the drop feeder.

15. The feeding system of claim 1, wherein the first adjustment lead comprises a tension cable.

16. The feeding system of claim 1, wherein the actuator handle is controlled electronically.

17. The feeding system of claim 1, wherein the actuator handle is positioned at the first end of the feed tube.

18. A feeding system for delivering feed to a plurality of stalls in a livestock building, the feeding system comprising:
a feed tube extending along a length of the feeding system;
a plurality of drop feeders connected to the feed tube, wherein each drop feeder comprises a container body that mates with the feed tube, a feed level control mechanism that selectively adjusts an amount of feed that collects in the container body, and an adjustment lever configured to manipulate the feed level control mechanism; and
a feed level adjustment system connected to the adjustment lever for each drop feeder of the plurality of drop feeders, the feed level adjustment system configured to simultaneously move the adjustment levers, wherein the feed level adjustment system comprises:
an actuator handle pivotably connected to a mounting bracket connected to the feed tube; and
an adjustment lead connected to the adjustment lever of each drop feeder and to the actuator handle, wherein movement of the actuator handle causes movement of the adjustment lead.

19. The feeding system of claim 18, wherein the feed level adjustment system further comprises:
another actuator handle connected to the feed tube at an end of the feed tube opposite the actuator handle; and
another adjustment lead connected to the actuator handle and the another actuator handle.

20. The feeding system of claim 18, wherein the actuator handle comprises a first actuator handle connected to a first end of the feed tube, the feed level adjustment system further comprising a second actuator handle connected to a second end of the feed tube, wherein the adjustment lead is connected to the first actuator handle and the second actuator handle.
